(19) United States
(12) Patent Application Publication
(10) Pub. No.: US 2024/0385745 A1
(43) Pub. Date: Nov. 21, 2024

(54) Multidirectional Gesturing For On-Display Item Identification and/or Further Action Control

(71) Applicant: Carnegie Mellon University, Pittsburgh, PA (US)

(72) Inventors: Aniket Kittur, Pittsburgh, PA (US); Brad A. Myers, Pittsburgh, PA (US); Xieyang Liu, Pittsburgh, PA (US)

(21) Appl. No.: 18/689,589

(22) PCT Filed: Sep. 15, 2022
(86) PCT No.: PCT/US2022/043604

§ 371 Date: Mar. 6, 2024

Related U.S. Application Data
(60) Provisional application No. 63/244,479, filed on Sep. 15, 2021.
(60) Provisional application No. 63/334,392, filed on Apr. 25, 2022.

(51) Int. Cl. G06F 3/04883; G06F 3/0485

(52) U.S. Cl. CPC G06F 3/04883; G06F 3/0485

(57) ABSTRACT

Methods of controlling a computing system based on wiggling and/or other types of continuous multidirectional gesturing. In some embodiments, the methods monitor user gesturing for the occurrence of a recognizable item-action gesture that a user has made without having provided any other input to the computing system and then take one or more actions in response to recognizing the item-action gesture. In some embodiments, the actions include identifying one or more on-display item underlying the item-action gesture, duplicating the identified item(s) to one or more target locations, and adding one or more visual indicia to the identified on-display item(s), among other things In some embodiments, a user can append an item-action gesture with one or more action extensions that each cause the computing system to take one or more additional actions concerning the identified on-display item(s). Software for performing one or more of the disclosed methodologies is also disclosed.

### RELATED APPLICATION DATA

This application claims the benefit of priority of U.S. Provisional Patent Application Ser. No. 63/244,479, filed Sep. 15, 2021, and titled “Wiggling for Low-cost Block Selection and Action”, and U.S. Provisional Patent Application Ser. No. 63/334,392, filed Apr. 25, 2022, and titled “Wiggling for Low-cost Block Selection and Action”, each of which is incorporated by reference herein in its entirety.

### GOVERNMENT RIGHTS

This invention was made with U.S. Government support under N00014-19-1-2454 awarded by the Office of Naval Research and under CCF1814826 awarded by the National Science Foundation. The U.S. Government has certain rights in the invention.

### FIELD OF THE INVENTION

The present invention generally relates to the field of human-machine interaction via onscreen gesturing to control computer action. In particular, the present invention is directed to multidirectional gesturing for on-display item identification and/or further action control.

### BACKGROUND

A common information need on the web is snipping or extracting web content for use elsewhere; for example, keeping track of chunks of text and photos and other graphics when performing any of a wide variety of tasks, such as researching potential travel destinations, copying and pasting paragraphs from news articles to put together as a briefing package, or collecting references for writing a scientific paper, among a nearly infinite number of other tasks. Conventional selection techniques built into today's web browsers and computer operating systems are generally designed for high-precision use that often comes at costs of time and effort. Users must manually specify start and end boundaries of a desired selection range through precise placements of an onscreen cursor on desktops or selection handles on mobile devices. When performed repeatedly, such high-precision-selection approaches can be cumbersome on desktops and especially challenging on smaller mobile devices. On such mobile devices, people are faced with small screen and font sizes, as well as the inaccuracy of finger-based touch interactions, resulting in multiple stressful and time-consuming micro-adjustments of the selection handles before being able to correctly select the desired content. Approaches to improving the selection experience have largely focused on optimizing the speed and accuracy of defining the start and end boundaries of a selection range, such as leveraging device bezels and special push gestures and taking advantage of the semantic structure of the content to be selected.

In addition to needing to use cumbersome item-action techniques, whether it be from consumers researching products, to patients making sense of medical diagnoses, to developers looking for solutions to programming problems, among many other examples, people spend a significant amount of time on the Internet discovering and researching different options, prioritizing which to explore next, and learning about the different trade-offs that make them more or less suitable for their personal goals, among other things. For example, a “YouTuber” seeking to upgrade her vlogging setup may learn about many different camera options from various online sites. As she discovers them, she implicitly prioritizes which are the most likely candidates she wants to investigate first, looking for video samples and technical reviews online that speak either positively or negatively about those cameras. Similarly, a patient might keep track of differing treatment options and reports on positive or negative outcomes; or a developer might go through multiple “Stack Overflow” posts and blog posts to collect possible solutions and code snippets relevant to their programming problem, noting trade-offs about each along the way.

While the number of options, their likely importance, and evidence about their suitability can quickly exceed the limits of the people's working memory, the high friction of externalizing this mental context means that people often still keep all this information in their heads. Despite the multiple tools and methods that people use to capture digital information, such as copying and pasting relevant texts and links into a notes app or email, taking screenshots and photos, or using a web clipper, collecting web content and encoding a user's mental context about it remains a cognitively and physically demanding process involving many different components. Indeed, just the collection component itself involves deciding what and how much to collect, specifying the boundaries of the selection, copying it, switching context to the target application tab or window, transferring the information into the application where it will be stored, causing frequent interruptions to the users' main flow of reading and understanding the actual web content, especially on mobile devices, such as smartphones. In addition, components such as prioritizing options by importance result in additional overhead to move or mark their expected utility, which can change as users discover new options or old assumptions become obsolete. When further investigating each option, to keep track of evidence about its suitability, a user further needs to copy and paste each piece of evidence (e.g., text or images from a review or link to a video) and annotate it with how positive or negative it is relative to the user's goals.

Beyond the cognitive and physical overhead of selecting and collecting content and encoding context, prior work suggests that for learning and exploration tasks, people are often uncertain about which information will eventually turn out to be relevant and useful, especially at the early stages when there are many unknowns. This could further render people hesitant to exert effort to externalize their mental context if that effort might be later thrown away.

### SUMMARY OF THE DISCLOSURE

In an implementation, the present disclosure is directed to a method of controlling a computing system via a visual display driven by the computing system. The method being performed by the computing system includes monitoring input of a user so as to recognize when the user has formed an item-action gesture; and in response to recognizing the item-action gesture without presence of another user-input action upon the computing system: identifying an on-display item, displayed on the visual display, that corresponds to the item-action gesture; and manipulating the identified on-display item.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a flow diagram illustrating an example method of controlling a computing device;

FIG. 2A is a diagram illustrating an example item-action gesture of a wiggling type, wherein the item-action gesture is formed by predominantly horizontal reciprocating movements;

FIG. 2B is a diagram illustrating the item-action gesture of FIG. 2A appended with one or more action-extension portions;

FIG. 3A is a diagram illustrating an example item-action gesture that is similar to the item-action gesture of FIG. 2A but with the item-action gesture formed by predominantly vertical reciprocating movements;

FIG. 3B is a diagram illustrating the item-action gesture of FIG. 3A appended with one or more action extension portions;

FIG. 4A is a diagram illustrating identification of one of four on-display items displayed on a visual display using an item-action gesture formed by predominantly horizontal reciprocating movements;

FIG. 4B is a diagram illustrating identification of two of the four on-display items of FIG. 4A using an item-action gesture formed by predominantly horizontal reciprocating movements;

FIG. 4C is a diagram illustrating identification of one of the four on-display items of FIG. 4A using an item-action gesture formed by predominantly vertical reciprocating movements;

FIG. 4D is a diagram illustrating identification of two of the four on-display items of FIG. 4A using an item-action gesture formed by predominantly vertical reciprocating movements;

FIG. 4E is a diagram illustrating identification of the same two of the four on-display items of FIG. 4D using an item-action gesture different from the item-action gesture of FIG. 4D;

FIG. 5A is a diagram illustrating an example curvilinear gesture that a user can use as an item-action gesture;

FIG. 5B is a diagram illustrating an example curvilinear gesture that a user has made along a procession direction;

FIG. 5C is a diagram illustrating the example gesture of FIG. 5A accompanied by various action extensions;

FIG. 5D1 is a diagram illustrating an example of using a reciprocating scrolling gesture as an item-action gesture, showing the displayed information in a scrolled-up position relative to an onscreen cursor;

FIG. 5D2 is a diagram illustrating the example of using a reciprocating scrolling gesture of FIG. 5D1, showing the displayed information in a scrolled-down position relative to the onscreen cursor;

FIG. 6A is a high-level block diagram of an example computing system that executes software that embodies methodologies of the present disclosure;

FIG. 6B is a high-level block diagram of an example computing environment for embodying the example computing system of FIG. 6A;

FIG. 7A are diagrams showing: an item-action gesture that selects an underlying item (top) and an extended item-action gesture that copies the underlying item (bottom);

FIG. 7B are diagrams showing: an item-action gesture and corresponding action extension that select an underlying item and assigns a positive (thumbs-up) rating (top) and an item-action gesture and corresponding action extension that select an underlying item and assigns a negative (thumbs-down) rating (bottom);

FIG. 7C are diagrams showing: an item-action gesture and corresponding action extension that select an underlying item and assigns a normal rating (top left); an item-action gesture and corresponding action extension that select an underlying item and assigns a low rating (bottom left); an item-action gesture and corresponding action extension that select an underlying item and assigns a high rating (top right); and an item-action gesture and corresponding action extension that select an underlying item and assigns a very high rating (bottom right);

FIG. 7D are diagrams showing item-action gestures corresponding, respectively, (top and bottom) to the item-action gestures of FIG. 7A and that are adapted to certain touchscreen-based devices;

FIG. 7E are diagrams showing item-action gestures corresponding, respectively, (top and bottom) to the item-action gestures and action extensions of FIG. 7B and that are adapted to certain touchscreen-based devices;

FIG. 8 is a screenshot of a graphical user interface of an example content capture, manipulation, and management tool;

FIG. 9A is a partial screenshot of a popup dialog box that the computing system displays after the user has performed an item-action gesture with an upwardly extending (high positive) priority-type action extension;

FIG. 9B is a partial screenshot of a popup dialog box that the computing system displays after the user has performed an item-action gesture with a downwardly extending (normal) priority-type action extension;

FIG. 9C is a partial screenshot of a popup dialog box that the computing system displays after the user has performed an item-action gesture;

FIG. 9D is a partial screenshot of a popup dialog box that the computing system displays after the user has performed an item-action gesture with a rightwardly extending (positive) rating-type action extension; and

FIG. 9E is a partial screenshot of a popup dialog box that the computing system displays after the user has performed an item-action gesture with a leftwardly extending (negative) rating-type action extension.

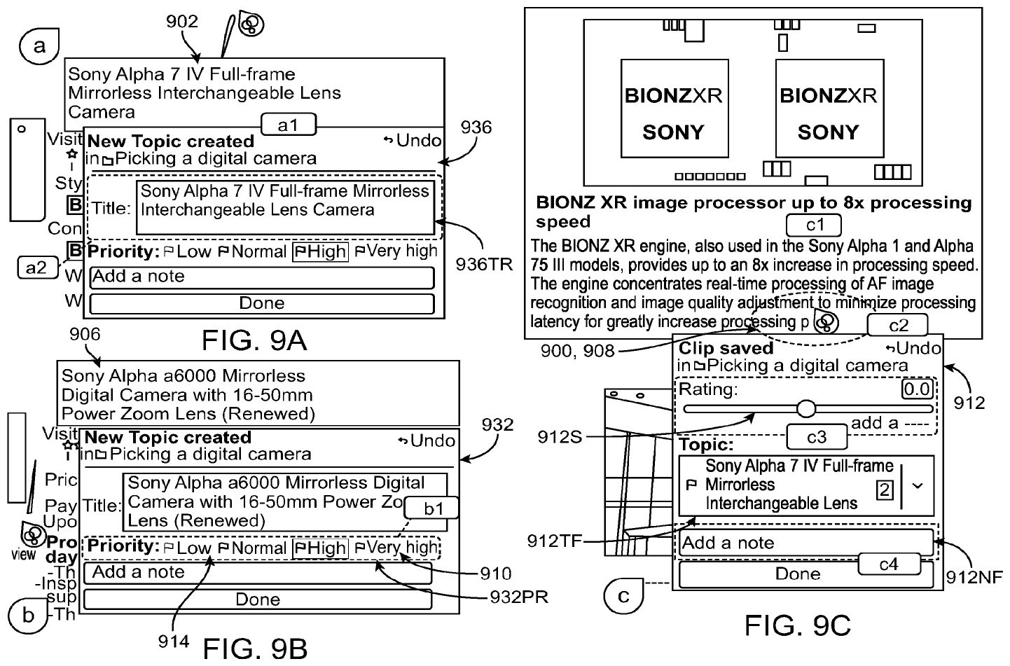

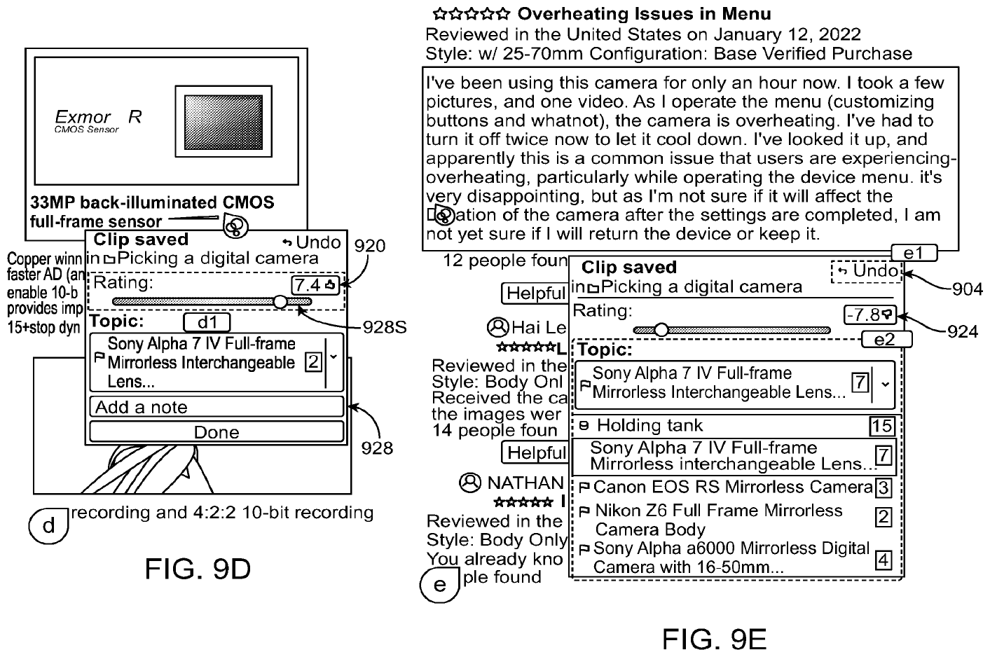

Any trademark and any copyrighted material appearing in the web content depicted in FIGS. 8 through 9E is the sole property of the respective owner.

### DETAILED DESCRIPTION

### 1. Definitions

As used herein and in the appended claims when referring to forming gestures, locations of gestures, and locations of pointers, certain terminology is framed relatively to the visual display on/in which information is presented to a user. For electronic-screen-based displays, it is customary for the display screen to have “lateral sides” that, when the display screen is displaying lines of English-language text for usual left-to-right reading, are typically perpendicular to such lines of text. In contrast, such display screens have a “top” and a “bottom” extending between the lateral sides, respectively, “above” and “below” the lines of text when the lines of text are in their usual reading orientations relative to a user. While projected displays and virtual displays can have differing parameters from electronic display screens, those skilled in the art will readily understand that projected displays and virtual displays will likewise have lateral sides, a top, and a bottom, as defined above relative to lines of English-language text. With these fundamental terms in mind, the following terms shall have the following meanings when used in any of the contexts noted above.

“Side-to-side”: The nature of reciprocating gesture formation and pointer movements that are primarily (i.e., form an angle of less than 45° with a line extending from one lateral side of the visual display to the other lateral side of the visual display in a direction perpendicular to the lateral sides) toward and away from the lateral sides of a visual display, regardless of the global orientation of the visual display.

“Up-and-down”: The nature of reciprocating gesture formation and pointer movements that are primarily (i.e., form an angle of less than 45° with a line extending from the top of the visual display to the bottom of the visual display in a direction perpendicular to the top and bottom) toward and away from the lateral sides of a visual display, regardless of the global orientation of the visual display.

“Horizontal”: A direction parallel to a line extending from one lateral side of the visual display to the other lateral side of the visual display in a direction perpendicular to the lateral sides, regardless of the global orientation of the visual display.

“Vertical”: A direction parallel to a line extending from a line extending from the top of the visual display to the bottom of the visual display in a direction perpendicular to the top and bottom, regardless of the global orientation of the visual display.

“Over”: When the visual display is displaying information within an item-display region of the visual display, a perceived position of a pointer in which, when a viewer is viewing the display region along a viewing axis perpendicular to the item-display region, the pointer occludes at least a portion of the item-display region.

“Under”, “underlying”: When the visual display is displaying information within an item-display region of the visual display, a perceived position of the item-display region relative to a pointer in which, when a viewer is viewing the display region along a viewing axis perpendicular to the item-display region, the pointer occludes at least a portion of the item-display region.

“Onto”: When the visual display is displaying information within an item-display region of the visual display, a perceived movement of a pointer by which, when a viewer is viewing the display region along a viewing axis perpendicular to the item-display region, the pointer occludes at least a portion of the item-display region.

### 2. General

In some aspects, the present disclosure is directed to methods of identifying at least one item displayed on a visual display of a computing system based on monitoring user input to recognize when the user makes an item-action gesture that is not accompanied by another user input, such as the pressing of a mouse button, pressing track-pad button, pressing of a joystick button, pressing of one or more keys of a keyboard, selecting a soft button or soft key, or the like. In some embodiments, an always-on gesture-recognition algorithm is used to automatically detect a user's gesturing This avoids a requirement of an explicit initiation signal, such as a keyboard key press or mouse key-down event that could conflict with other actions and has the benefit of combining activating and performing the item-action gesture together into a single step, therefore reducing the starting cost of using the technique.

Before proceeding, it is noted that in differing embodiments the user may form the item-action gesture in differing manners depending on context. For example, the user may form an item-action gesture by moving a pointer relative to an electronic display screen on which information (e.g., a webpage) is displayed. Examples of input types in which movement of the pointer is defined in this manner include touchscreen gesturing (e.g., using a finger, stylus, or other passive object that the user moves relative to a touchscreen and that functions as a physical pointer) and gesturing by moving an onscreen cursor (i.e., a virtual pointer) relative to a display screen (e.g., using a computer mouse, a trackball, a joystick, a touchpad, a digitizer, or other user-controlled active device). As another example, the user may form an item-action gesture using an input that is not a pointer, such as a scroll wheel (e.g., of a computer mouse) that acts to scroll information (e.g., a webpage) being displayed on the display. Scrolling can also be used in other contexts. For example, in touchscreen-based computing systems, such as mobile devices, the underlying operating system, an app, a browser, a plugin, etc., may interpret a user's up-and-down touchscreen gesturing as scrolling gesturing that causes the on-screen items to scroll in the direction of the gesturing.

As discussed in detail below, the item-action gesture may have any of a variety of forms. For example, the item-action gesture may have a multidirectional trajectory that the computing system is preconfigured to recognize as signifying a user's intent on having the computing system selecting one or more on-display items located under the item-action gesture or a portion thereof. Examples of multidirectional trajectories include wiggles (e.g., repeated predominantly side-to-side or repeated predominantly up and down movements, either in a tight formation (generally, abrupt changes in direction between contiguous segments of 0° to about 35°) or in a loose formation (abrupt changes in direction between contiguous segments of greater than about 35° to less than about 100°) or both), repeating curvilinear trajectories (e.g., circles, ovals, ellipses, etc.) that either substantially overlay one another or progress along a progression direction, or a combination of both, among others. As another example of a form, an item-action gesture may be a reciprocating up-and-down movement (scrolling) of information displayed on the relevant display.

Once the computing system recognizes the item-action gesture, it performs one or more predetermined tasks in accordance with the particular deployment at issue. For example, a first task is typically to identify one or more items, e.g., word(s), sentence(s), paragraph(s), image(s), heading(s), table(s), etc., and any combination thereof, underlying the item-action gesture to become one or more identified items. In some embodiments in which a user has already selected one or more on-display items, for example, via an app using a conventional selection technique, the identification based on the item-action gesture can be the selected item(s) or portion thereof, either alone or in combination with one or more non-selected on-display items, as the case may be. In such and other embodiments, the item-action gesture and corresponding functionality is completely independent of conventional selection techniques and functionality.

In some embodiments, the computing system performs one or more additional predetermined tasks beyond identification based on the recognition of the item-action gesture. Examples of additional predetermined tasks include, but are not limited to, adding one or more visual indicia to one or more of the identified items, duplicating the identified item(s) to a holding tank, duplicating the selected item(s) to one or more predetermined apps, and/or activating the identified item(s) to make it/them draggable, among other things, and any logical combination thereof, in many cases without making or changing a selection. Examples of visual indicia include highlighting of text or other alphanumeric characters/strings, adding one or more tags, changing the background color of the selected item, etc., and any logical combination thereof. Examples of actions that the computing system may take following recognition of the item-action gesture are described below.

In some embodiments, an item-action gesture may be partitioned into two or more control segments, with the computing system responding to recognition of each control segment by performing one or more tasks. For example, a wiggling gesture (e.g., side-to-side or up-and-down) may be partitioned into two segments, such as a suspected-gesture segment and a confirmed-gesture segment. In an example, the computing system may suspect that a user is performing a wiggling gesture after detecting that the user has made a continuous gesture having three abrupt directional changes, with the three directional changes defining the suspected-gesture segment. As an example, this may cause the computing system to perform one or more tasks, such estimating which underlying item(s) the user may be selecting with the suspected-gesture segment, changing the background color, for example to a hue of relatively low saturation, and/or changing the visual character or an onscreen cursor (if present) and/or adding a visible trace of the wiggling gesture so as to provide visual cues to the user that the computing system suspects that the user is performing a full-fledged item-action gesture. Then, if the user continues making the continuous gesture such that it has at least one additional abrupt directional change and the computing system detects such additional abrupt directional change, then the computing system uses the fourth detected directional change to indicate that the user's gesture is now in the confirmed-gesture segment. Once the computing system recognizes that the gesture is in the confirmed-gesture segment, the computing system may take one or more corresponding actions, such as increasing the saturation of the background hue that the computing system may have added in response to recognizing the suspected-gesture segment, (again) changing the visual character or an onscreen cursor (if present) and/or adding/changing a/the visible trace of the wiggling gesture so as to provide visual cues to the user that the computing system has recognized that the user is performing a full-fledged item-action gesture, activating the identified item(s), copying and/or pasting and/or saving the identified item(s), etc. Those skilled in the art will readily understand that this example is provided simply for illustration and not limitation. Indeed, skilled artisans will recognize the many variations possible, including, but not limited to, the type(s) of item-action gesture, the number of gesture segments, and the nature of the task(s) that the computing system performs for each gesture segment, among other things.

In some embodiments, an item-action gesture may have one or more action extensions that, when the computing system recognizes each such action extension, causes the computing system to perform one or more predetermined actions beyond the task(s) that the computing system performed after recognizing the initial item-action gesture. As with the item-action gesture, an action extension is performed continuously in one gesture. In addition, each action extension is a continuation of the same gesture that provides the corresponding item-action gesture. In the context of performing a gesture traced out by an onscreen cursor, the user performs each action extension by continuing to move the cursor in a generally continuous manner (except, e.g., for any abrupt direction change(s)) following finishing the item-action gesture. In the context of performing a gesture by engaging a pointer with a touchscreen, the user performs each action extension by continuing to make a gesture without breaking contact between the pointer and the touchscreen.

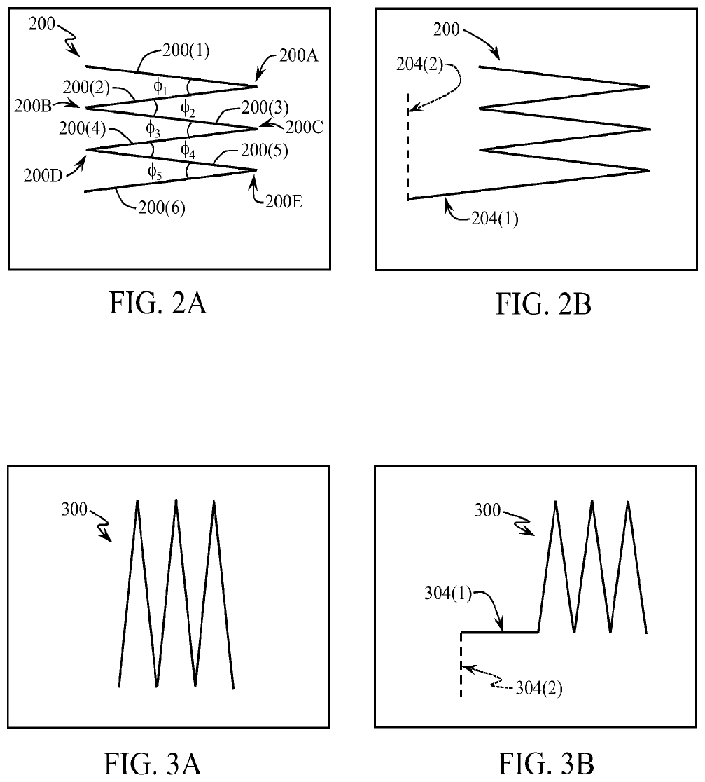

Examples of actions that an action extension may cause the computing system to perform include, but are not limited to, assigning a rating to the identified item(s), assigning a value to an assigned rating, capturing the identified item(s), deselecting the captured item(s), assigning a priority level to the identified item(s), and assigning the identified item(s) to one or more groups or categories, among others, and any logical combination thereof. Action extensions can have any suitable character that distinguishes them from the item-action gesture portion of the overall gesturing For example, for a wiggling gesture composed of generally back-and-forth (or, e.g., up-and-down) gesturing composed of generally linear segments, an action extension may be a final generally linear segment having, for example, a length that is longer than any of the segments of the item-action gesture and/or may have a specific required directionality. Similarly, for a repeating curvilinear gesture, an action extension may be a final generally linear segment that extends beyond the relevant extent of the item-action gesture in any given direction and/or may have a specific directionality. As another example of distinguishing character, an action extension may be defined by a delayed start relative to the corresponding item-action gesture. For example, the computing system may be configured to recognize a pause after the user forms an item-action gesture before continued gesturing by the user as characterizing the action extension. In this example, the pause may be defined by a certain minimum amount of time, such as a predetermined number of milliseconds. Action extensions can be more complex, such as being more akin to the item-action gesture, if desired. However, it is generally preferred from a processing-effort standpoint to keep action extensions relatively simple. It is noted that two or more action extensions can be chained together with one another to allow a user to cause the computing system to perform corresponding sets of one or more actions each. Detailed examples of action extensions and corresponding item-action gestures are described below and visually illustrated in FIGS. 2B, 3B, 5C, 7B, 7C, 9A, 9B, 9D, and 9E.

In some aspects, the present disclosure is directed to software, i.e., computer-executable instructions, for performing any one or more methods disclosed herein, along with computer-readable storage media that embodies such computer-executable instructions. As those skilled in the art will readily appreciate from reading this entire disclosure, any one or more of the disclosed computer-based methods may be embodied in any suitable computing environment in any manner relevant to that environment. A detailed example of a web browser in an Internet environment is provided below in Section 4. However, deployment of methods disclosed herein need not be so limited. For example, disclosed methods may be deployed in any information-gathering software tool, a word processing app, a presentation app, a PDF reader app, a digital-photo app, a mail reader app, a social media app, and a gaming app, among many others. Fundamentally, there are no limitations on the deployment of methods and software disclosed herein other than the target deployment of items that users want to identify and/or perform other tasks/actions on and that the deployment be compatible with the relevant type of gesturing and gesture recognition.

### 3. Example Methods and Gesturing

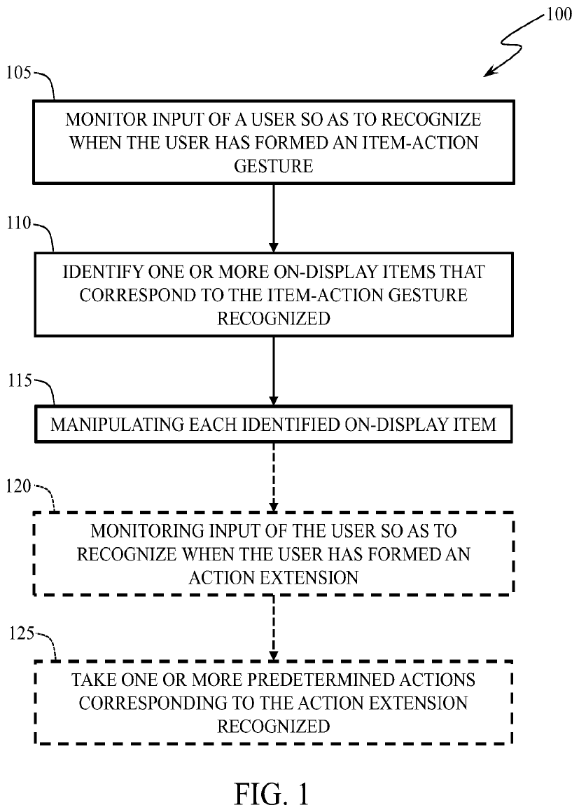

Turning now to the drawings, FIG. 1 illustrates an example method 100 that includes an item-action method as discussed above, which here is embodied in a method of controlling a computing system, which can include any one or more suitable types of computing devices, such as laptop computers, desktop computers, mobile computing devices (e.g., smartphones, tablet computers, etc.), servers, and mainframe computers, or any combination thereof, among others, and any necessary communications networks. The method 100 involves controlling the computing system via a visual display associated with the computing system. In some embodiments, the visual display is an electronic-screen-based visual display, such as, for example, a laptop display screen, a desktop display screen, a smartphone display screen, or a tablet computer display screen, among others, or any suitable combination thereof. In some embodiments, the visual display is of a type other than an electronic-screen-based display, such as a projected display or a virtual display of, for example, an augmented reality system or a virtual reality system, among others. Fundamentally, methods of the present disclosure, such as the method 100, may be adapted to any type of visual display(s), as those skilled in the art will readily appreciate from reading this entire disclosure.

At block 105, the computing system monitors input from a user so as to recognize when the user has formed an item-action gesture. In some embodiments, such as non-touchscreen-based embodiments, the input may be the movement of an onscreen cursor that a user moves using an active input device, such as, for example, a computer mouse, a track pad, a joystick, a digitizer, a trackball, or other user-manipulatable input device and/or the scrolling of information displayed on the visual display, such that the user may effect using a scroll wheel or other input device. In some embodiments, such as touchscreen-based embodiments, the input may be movement of a user's finger, a stylus, or other passive or active pointing object. In some embodiments, such as projected-display-based embodiments or virtual-display-based embodiments, the input may be movement of any pointer suitable for the relevant system, such as a user's finger (with or without one or more fiducial markers), one or more fiducial markers or position sensors affixed to a user's hand or a glove, sleeve or other carrier that the user can wear, or a pointing device having one or more fiducial markers or position sensors, among others. Fundamentally and as those skilled in the art will readily appreciate from reading this entire disclosure, methods of the present disclosure, such as the method 100, may be adapted to any type of pointer suited to the corresponding type of visual display technology.

The computing system may perform monitoring at block 105 using any suitable method. For example, computer operating systems typically provide access via an application programming interface (API) to low-level display-location mapping routines that map the location of the pointer to a location on the visual display. These and other display-location mapping routines are ubiquitous in the art and, therefore, need no further explanation for those skilled in the art to implement methods of the present disclosure to their fullest scope without undue experimentation. As noted above, the input may, for example, be a user moving a scroll wheel to scroll a page displayed on the visual display. In this example, the API may provide access to low-level scroll-control routines for recognition of scroll-based item-identification gestures.

The computing system may recognize the item-action gesture using any suitable gesture-recognizing algorithm. Many gesture-recognition algorithms have been developed over the years since human-machine-interface (HMI) gesturing was invented for user input and control of computing systems. Some gesture-recognition algorithms are more processing intensive, or heavyweight, than others, depending on the character of the gesture(s) and the number of gestures that a particular gesture-recognition algorithm is designed to recognize. For example, some gesture-recognition algorithms involve training, classification, and/or matching sub-algorithms that can be quite processing intensive. While these can be used to implement methods disclosed herein, some embodiments can benefit from lighter-weight gesture-recognition algorithms.

For example, software for implementing a method of the present disclosure, such as the method 100, may utilize a gesture-recognition algorithm that is optimized for recognizing specific gesturing features rather than. for example, attempting to match/classify an entire shape/pattern of a performed gesture with a shape/pattern template stored on the computing system. As a simple example of a lightweight gesture-recognition algorithm, the algorithm may be configured for use only with wiggling gestures having multiple segments defined by multiple abrupt changes in direction, with the angles formed by immediately adjacent segments being acute angles. An example of such a gesture is illustrated in FIG. 2A.

Referring to FIG. 2A, the item-action gesture 200 shown is a back-and-forth gesture having six segments 200(1) to 200(6) and five corresponding abrupt directional changes 200A to 200E defining, respectively, five acute angles ϕ₁ to ϕ₅. In this example, the gesture-recognition algorithm may be configured to continuously monitor movement of the pointer for the occurrence of, say, generally back-and-forth movement and three abrupt directional changes occurring within a predetermined window of time. In this example, once the gesture-recognition algorithm recognizes that these events have just occurred, it may generate a signal that indicates that the user has just input an item-action gesture of the method, such as the method 100.

Alternatively, as discussed above, in some embodiments affirmative recognition of an item-action gesture may be a multi-step process. In the context of the example item-action gesture 200 of FIG. 2A, the gesture-recognition algorithm may use, for example, the first three abrupt directional changes 200A to 200C to suspect that the user is in the process of inputting an item-action gesture and may take one or more actions based on this suspicion, for example, as discussed above. Then, the gesture-recognition algorithm continues to monitor the movement of the pointer and if it determines that two additional abrupt directional changes, here the abrupt directional changes 200D and 200E, occur within a predetermined amount of time, then it will affirmatively recognize the gesturing as an item-action gesture. Those skilled in the art will readily appreciate that these or similar lightweight gesture-recognition algorithms can be used to recognize gestures of other shapes/patterns, such as repeating curvilinear gestures, among others.

As noted above in the previous section, the directionality of an item-action gesture may differ depending on aspects of the computing system at issue, more specifically, the type of visual display, type of pointer, and the manner in which the computing system's operating system handles gesturing to effect various user control. For example, computing systems that use an onscreen cursor controlled by the user using an active input device, such as a computer mouse, user movement of the onscreen cursor without the user actuating another control, such as a mouse button, keyboard key, etc., simply moves the onscreen cursor around the screen without taking another action or having any other effect on the computer. In such computing systems, an item-action gesture composed of predominantly side-to-side movements may be most suitable for item-action purposes. However, computing systems that use touchscreen gesturing often use up-and-down movements to scroll a webpage or other information displayed on the touchscreen and ignore repeated side-to-side movements. In such computing systems, an item-action gesture composed primarily of up-and-down movements may be most suitable for item-action purposes. FIG. 3A illustrates an example predominantly up-and-down item-action gesture 300 that is an analog to the predominantly side-to-side item-action gesture 200 of FIG. 2A.

Referring again to FIG. 1, at block 110, in response to recognizing the item-action gesture, without the presence of another (e.g., any other) user-input action upon the computing system, the computing system determines one or more on-display items, displayed on the visual display, that correspond to the item-action gesture. To make this determination, the method 100 may utilize an item-determination algorithm that uses gesture-mapping information and display-content mapping information to determine (which includes estimate) the one or more on-display items that the user is intending to identify via the item-action gesture. The nature of the item(s) that are identifiable may vary depending on the deployment at issue and the type of information that can be identified. For example, in a deployment that involves identifying items displayed on web pages, the identifiable items may be at least partially defined by objects within a document object model (DOM) tree, such as an extensible markup language (XML) document or a hypertext markup language (HTML.) document. Examples of DOM-tree objects include, but are not limited to headings, paragraphs, images, tables, etc. Mapping of the item-action gesture to the corresponding item in the DOM tree can be performed, for example, using known algorithms that can be integrated into the item-determination algorithm. In some embodiments, the identifiable items may be portions of DOM-tree objects, such as individual words within a paragraph or heading, individual sentences within a paragraph, and individual entries within a table, among other things. In a DOM-tree-document environment, the item-determination algorithm may be augmented with one or more portion-identification sub-algorithms for determining such portion identifications. Those skilled in the art will readily be able to devise and code such portion-identification algorithms using only routine skill in the art. While the DOM-tree-document example is a common example for illustrating item identification, many other documents and, more generally, information display protocols exist. Those skilled in the art will readily appreciate that methods of the present disclosure, including the method 100 of FIG. 1, can be readily adapted to determine identifications from within information displayed using any one or more of these display protocols.

At block 110, the item-determination algorithm may use any one or more of a variety of characteristics of the recognized item-action gesture and display mapping data for the characteristic(s) for determining which item(s) to identify. For example, the item-determination algorithm may use, for example, a beginning point or beginning portion of the item-action gesture, one or more extents (e.g., horizontal, vertical, diagonal, etc.) of a gesture envelope, or portion thereof, containing the item-action gesture, or portion thereof relative to the on-display information underlying the item-action gesture and/or the progression direction of the gesturing resulting in the item-action gesture, among other characteristics, to determine the identification.

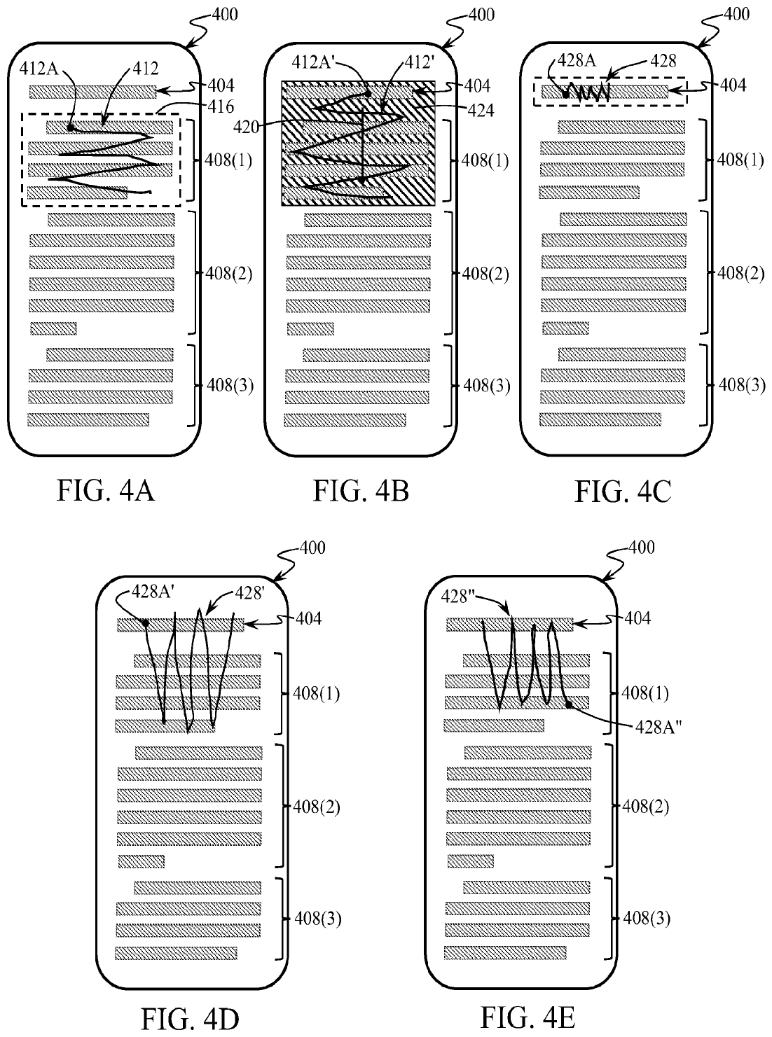

Following determination of which one or more on-display items the user (not shown) has identified or appears to have identified, and also in response to recognizing the item-action gesture without the presence of another (e.g., any other) user-input action upon the computing system, at block 115 the computing system manipulates each identified on-display item(s). Manipulation at block 115 may include any suitable manipulation, such as, but not limited to, duplicating to a holding tank, duplicating the identified item(s) to a popup window, duplicating the identified item(s) to a predetermined on-display location, duplicating the identified item(s) to one or more apps, and/or providing one or more visual indicia (not shown), such as any sort of background shading, text highlighting, or boundary drawing, etc., among many others, and any suitable combination thereof. FIGS. 4A-4E show some example item-action gestures and corresponding items that the item-determination algorithm determines to be the items that the user (not shown) is intending to identify an action, along with example visual identifications of the corresponding identified items. While these examples are limited in terms of the specific item-action gestures illustrated and the types of selected/selectable items illustrated, those skilled in the art will be able to use these examples to generalize to many other item-action gestures and other types of selected items using these examples as a guide and common knowledge in the art.

FIG. 4A shows a visual display 400 displaying on-display information presented as a heading 404 and three paragraphs 408(1) to 408(3). In this example the user (not shown) has performed wiggling item-action gesture 412 that the gesture-recognizing algorithm has recognized Based on the recognition of the item-action gesture 412, the item-determination algorithm has then determined that the user's intention was to identify only paragraph 408(1). In this example, the item-determination algorithm has used 1) the fact that the initiation point 412A of the item-action gesture 412 is located within the underlying paragraph 408(1) to initially determine paragraph 408(1) to be a subject of the user's identification, and 2) the fact that the entirety of the item-action gesture remains within the bounds of paragraph 408(1) to make a final determination that the user has indeed intended to identify only paragraph 408(1). In this example, the identification is indicated by the dashed envelope 416 that envelopes the identified item. In other embodiments, the identification of the item for action, here, paragraph 408(1), may be evidenced in another manner.

FIG. 4B shows the same display 400 and on-display information in the form of the heading 404 and the three paragraphs 408(1) to 408(3). However, in this example, the user (not shown) has made an item-action gesture 412′ that is of the same general character as the item-action gesture 412 of FIG. 4B but has a differing vertical extent that indicates that the user is desiring that the computing system identify two of the four on-display items, here the heading 404 and the paragraph 408(1). In this example, the user initiated the item-action gesture 412′ at an initiation point 412A′ that is over the heading 404, which the item-determination algorithm interprets to identify the heading. The user then continued to make the item-action gesture 412′ by making zig-zagging movements of the pointer (not shown) in a progression direction 420 down the visual display 400 so that a portion of the item-action gesture was now over the paragraph 408(1) and ended the item-action gesture within the bounds of that paragraph. The item-determination algorithm interpreted these features of the item-action gesture 412′ to indicate the user's desire to identify the paragraph 408(1) and then identify that paragraph. In this example, the identification driven by the item-determination algorithm is visually indicated by adding background shading to the heading 404 and the paragraph 408(1) as denoted by cross-hatching 424. Of course, the manner of indicating the identification can be different as discussed above in connection with FIG. 4A.

FIGS. 4A and 4B involve using item-action gestures 412 and 412′, respectively, that are formed by predominantly horizontal reciprocating movements. For the sake of illustration, FIGS. 4C and 4D show, respectively, the same identifications made using item-action gestures 428 and 428′ of the same general character but that are formed by predominantly vertical reciprocating movements. In FIG. 4C, the user is desiring to identify only the heading 404. In this example, the user then starts the item-action gesture 428 at an initiation point 428A located over the heading 404 and performs relatively small predominantly vertical reciprocating movements that stay substantially over at least some portion of the heading. In this example, the item-determination algorithm (see, e.g., block 110 of FIG. 1) uses the location of the initiation point 428A and the small envelope of the rest of the item-action gesture 428 to determine that the user appears to be desiring to identify only the heading 404.

FIG. 4D, which is an analog to FIG. 4B, shows that a user is desiring to select both the heading 404 and the paragraph 408(1) located just beneath the heading. In this example, the user then starts the item-action gesture 428′ at an initiation point 428A′ located over the heading 404 and performs relatively large predominantly vertical reciprocating movements that proceed over at least some portion of each of the heading and the adjacent paragraph 408(1). In this example, the item-determination algorithm (see, e.g., block 110 of FIG. 1) uses the location of the initiation point 428A′ and the large envelope of the rest of the item-action gesture 428′ that extends over both the heading and the adjacent paragraph 408(1) to determine that the user appears to be desiring to select both the heading and the adjacent paragraph.

It is noted that the user could have selected both the heading 404 and the adjacent paragraph 408(1) in another manner using similar gesturing. For example, and as shown in FIG. 4E, the user could have placed the initiation point 428A″ of the item-action gesture 428″ within the paragraph 408(1) and continued gesturing in a way that portions of the item-action gesture overlay at least a portion of the heading 404. As can be readily seen in FIG. 4E, the item-action gesture 428″ is clearly present over both the heading 404 and the adjacent paragraph 408(1).

Referring back to FIG. 1, the method 100 can optionally be enhanced with any one or more of a variety of additional features. For example, the method 100 may optionally include, at block 120, the computing system monitoring movement by the user of the pointer so as to recognize at least one action extension of the item-action gesture. In some embodiments, an action extension is a predetermined gesturing appended to the item-action gesture recognized at block 105 of the method 100. A user typically performs the action extension as part of a continuous set of movements of the pointer in making the item-action gesture and the one or more desired action extensions. In some embodiments, the extension-recognition algorithm may recognize the presence of an action extension by one or more characteristics of the gesturing that defines the action extension. Simple action extensions include largely linear movements that are larger than similar movements the user made to make the initial item-action gesture. Consequently, the extension-recognition algorithm may be configured to look for largely linear segments that are relatively large, for example by extending relatively far beyond the predicted envelope of the initial item-action gesture. In some embodiments, only a single action extension is permitted and, if this is the case, then the extension-recognition algorithm may also look to determine whether the gesturing at issue is a final segment of the gesturing. In some embodiments, the extension-recognition algorithm may use directionality of an action extension to assist in recognizing whether or not a continued gesture movement is an action extension. FIG. 2B illustrates the item-action gesture 200 of FIG. 2A appended with a first action extension 204(1) and an optional second action extension 204(2). Similarly, FIG. 3B illustrates the item-action gesture 300 of FIG. 3A appended with a first action extension 304(1) and an optional second action extension 304(2).

When the computing system recognizes an action extension at block 120, at block 125 the computing system will take one or more predetermined actions corresponding to the action extension just recognized. Example uses of action extensions include various types of rating actions for rating the selected item(s) that the computing system identified via the corresponding item-action gesture. One example of a rating scheme is to assign the identified item(s) either a positive rating or a negative rating. In this example, the valance of the rating (i.e., positive or negative) may be assigned by directionality of an action extension. For example, a negative rating may be mapped to an action extension that is gestured toward the left and/or downward, while a positive rating may be mapped to an action extension that is gestured to the right and/or upward. In each case, the action the computing system may take is assigning either a thumbs-up emoji (positive valence) or a thumbs-down emoji (negative valence) or some other visual indicator of the corresponding rating and display such visual indicator. It is noted that in some embodiments using such positive and negative ratings, not appending any action extension to the item-action gesture may result in the computing system assigning a neutral valence or not assigning any valence.

Some embodiments of rating-type action extensions may be augmented in any one or more of a variety of ways. For example, in addition to assigning a valence, the computing system may use the same or additional action extensions to assign a magnitude to each valence. For example, the relative length of the same action extension may be used to assign a numerical magnitude value (e.g., from 1 to 5, from 1 to 10, etc.). As another example, the length of an additional action extension may be used to assign the numerical magnitude value. In some embodiments, the additional action extension may be differentiated from the initial action extension by abruptly changing the direction of the continued gesturing as between the initial and additional action extension. FIG. 3B can be used to illustrate this. In FIG. 3B, the first action extension 304(1) may assign a negative rating, and the second action extension may assign a value of −5 (out of a range of −1 to −10) to that rating. Another example of using an additional (e.g., second) action extension is to cancel an identification. For example, if the first action extension assigns either a thumbs-up or thumbs-down emoji based on direction, a second action extension may allow the user to cancel the identification of the identified item(s) and/or the assigned rating. Again in the context of FIG. 3B, say the first action extension 304(1) assigns a negative rating, if the user changes her mind, the user can continue the gesturing after the first action extension to create the second, cancellation action extension 304(2), to cause the computing system to cancel the selected item(s) and/or the assigned rating. These are but a few examples of how action extensions can be used, and those skilled in the art will be able to devise many other uses of a single action extension or multiple chained action extensions.

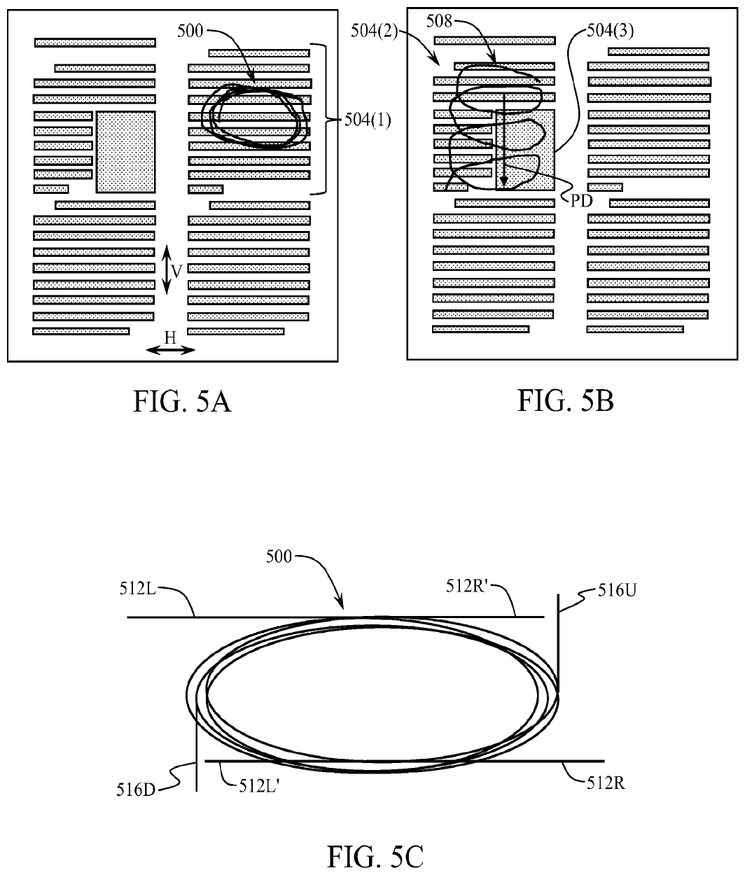

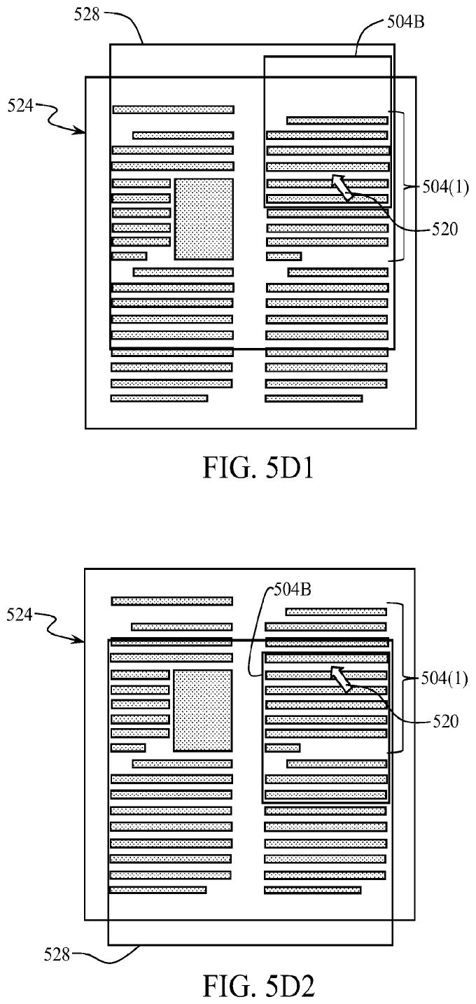

While the examples of FIGS. 2A through 4E utilize various types of wiggling gestures for the corresponding item-action gesture, as mentioned above in section 2, gestures for item-action gestures need not be wiggling gestures. While wiggling gestures are easy for users to make and adjusts the size and extent of to make “on the fly” adjustments to desired identifications, other types of gestures can have similar benefits. For example, curvilinear gestures can be easy for users to make and adjust in size and extent. FIG. 5A illustrates a generally ellipsoidal gesture 500 that a method of the present disclosure can use as the item-action gesture. This example shows the gesture 500 being large relative to an underlying on-display item 504(1) for selecting the entire on-display item. However, the gesture 500 can be as large or as small as the user desires for making a corresponding identification of one or more items in either or both of the vertical (V) and horizontal (H) directions. As illustrated in FIG. 5B, in some embodiments the user can make the same general motions as in FIG. 5A but make them in a procession direction (PD), for example, to make an item-action gesture 508 that causes the computing system to select multiple on-display items that are adjacent to one another along the procession direction, here the underlying on-display items 504(2) and 504(3). While the procession direction PD is shown as being vertically downward, those skilled in the art will readily appreciate that the procession direction may be in any direction depending on the deployment at issue and/or variability in on-display locations of underlying selectable items. In some embodiments, a user may change the procession direction PD one or more times during the formation of the item-action gesture 508 depending on the on-display locations of the on-display identifiable items.

As seen in FIG. 5C, the gesture 500 can be appended with one or more action-extensions, such as action extensions 512 (512R (rightward), 512L (leftward)) and 516 (516U (upward), 516D (downward)) that cause the computing system to perform one or more additional actions. In a rating context, action extensions 512R and 516U may each be used to have the computing system assign a positive rating to the identified item(s) underlying the gesture 500, whereas action extensions 512L and 516D may each be used to have the computing system assign a negative rating to the identified item(s) underlying the gesture 500. It is noted that these action extensions 512 and 516 are suited for the user making the gesture 500 in a counterclockwise direction and that they may be different when the gesture 500 is made in a clockwise direction. It is also noted that some deployments may use only either action extensions 512 or action extensions 516. However, some deployments may use both action extensions 512 and action extensions 516, for example, for differing types of ratings.

Further, it is noted that a user need not make the gesture 500 only in one direction. For example, the user may make the gesture 500 in a counterclockwise direction and make the action extension 512R′ for a positive rating but in a clockwise direction and make the action extension 512L′ for a negative rating. As yet another alternative, some embodiments may use the initial gesture 500 itself for assigning a rating. For example, a counterclockwise formation of the gesture 500 may cause the computing system to assign a positive rating, and a clockwise formation of the gesture 500 may cause the computing system to assign a negative rating. In these examples of rating being assigned by formations in differing directions, action extensions, such as action extensions 512R and 512L′ may be used to apply a value to the corresponding rating, for example, with computing system mapping the relative length of each action extension to a corresponding numerical value. It is noted that this directionality of formation of a gesture can be used for gestures of other types, such as wiggling gestures, among others. While FIG. 5C illustrates the gesture 500 appended with only single action extensions 512 and 516, as discussed above, the gesture can be appended with two or more action extensions daisy-chained with one another as needed or desired to suit a particular deployment.

FIGS. 5D1 and 5D2 illustrate the same on-display items as in FIG. 5A, including paragraph 504(1) that the user is desiring to identify for further action. In contrast to FIG. 5A, wherein the user formed the item-action gesture 500 by moving a pointer (not shown) to effectively draw out a shape over the desired paragraph 504(1), in FIGS. 5D1 and 5D2 the user is causing the page 504 of which paragraph 504(1) is part to repeatedly scroll up (FIG. 5D1) and scroll down (FIG. 5D2) while a corresponding on-screen cursor 520 remains stationary on the display screen 524. Those skilled in the art will readily appreciate that the user may control movement of the screen cursor 520 via, for example, a computer mouse (not shown), and may control scrolling via, for example, a scroll wheel (not shown) that is part of the computer mouse.

As illustrated, the individual lines of paragraph 504(1) denoted by the brackets in FIGS. 5D1 and 5D2 are the locations of these lines on the display screen 524 before the user has performed any scrolling. In FIG. 5D1, bounding box 504B indicates the general bounds of paragraph 504(1) after the user has scrolled the original content (see FIG. 5A and as represented in FIG. 5D1 by bounding box 528) of the display screen 524 upward so as to cause a portion of the original content to scroll off the top of the display screen. In FIG. 5D2, the user has scrolled the original content of the display screen 524 downward so that a portion of the original content (as denoted by bounding box 528) has scrolled off the bottom of the display screen.

In this example, the gesture-recognition algorithm may be configured to recognize that three or more relatively rapid changes in scrolling directions (up-to-down/down-to-up) indicates that the user is making an item-action gesture. Relatedly, the item-detection algorithm in this example may use the fact that the onscreen cursor 520 remains wholly within the bounding box 504B during the entirety of the user's scrolling actions to understand that the user is intending the computing system to select only paragraph 504(1) with the item-action gesture.

While not illustrated, a cursorless example in a touchscreen context involves a user touching the touchscreen, e.g., with a finger, over an item, over one of multiple items, or between two items that the user desires the computing system to identify and act upon. In this example, the user then moves their finger up and down relative to the touchscreen by amounts that generally stay within the bounds of the item(s) that they desire the computing system to identify for action. While this gesturing will cause the on-display items to scroll in the corresponding directions, the item-detection algorithm can use the original screen location(s) of the on-screen item(s) and the extent of the item-action gesture to determine which onscreen item(s) the user intended to identify.

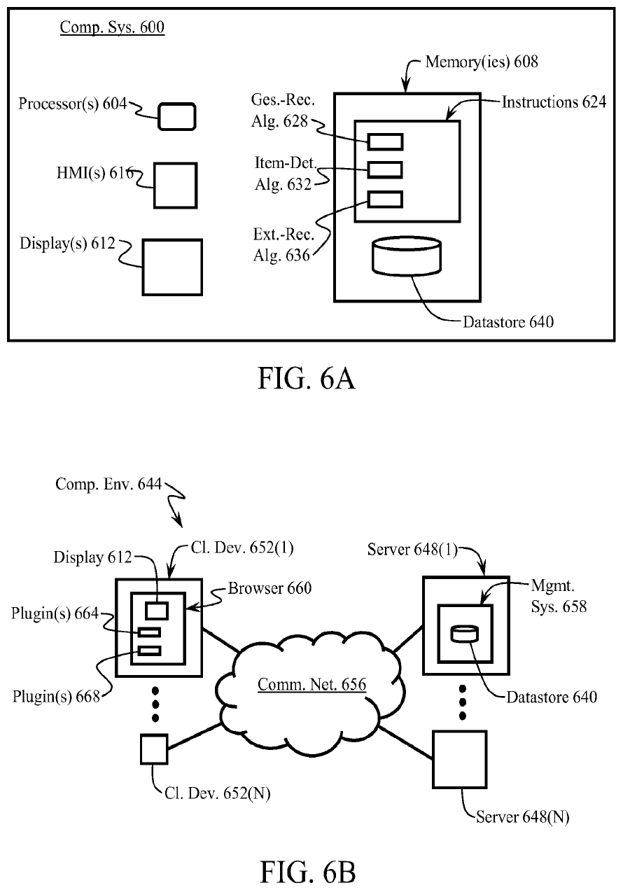

FIG. 6A illustrates an example computing system 600 for executing software that implements methodologies of the present disclosure, such as the method 100 of FIG. 1, one or more portions thereof, and/or any other methodologies disclosed herein. As will be readily appreciated, the computing system 600 is, in general, illustrated and described only in terms of hardware components, software components, and functionalities relevant to describing primary aspects and features of the methodologies disclosed herein. Consequently, conventional features and aspects of the computing system 600, such as any network interfaces, network connections, operating system(s), communications protocols, etc., are intentionally not addressed. Those skilled in the art will understand how the unmentioned features and aspects of the computing system 600 may be implemented for any manner of deploying the selected methodologies disclosed herein. In this connection, and as will be illustrated in connection with FIG. 6B, described below, the computing system 600 may be implemented on a single computing device, such as a laptop computer, desktop computer, mobile computer, mainframe computer, etc., or may be distributed across two or more computing devices, including one or more client devices and one or more server devices interconnected with one another via any one or more data networks, including, but not limited to, local-area networks, wide-area networks, global networks, or cellular networks, among others, and any suitable combination thereof.

The example computing system 600 includes one or more microprocessors (collectively represented at processor 604), one or more memories (collectively represented at memory 608), and one or more visual displays (collectively represented at visual display 612). For the sake of convenience, each of the processor(s) 604, memory (ies) 608, and visual display(s) 612 will be referred to in the singular even though many actual instantiations of the computing system will include at least two or more of each of these components. The processor 604 may be any suitable type of microprocessor, such as a processor aboard a mobile computing device (smartphone, tablet computer, etc.), laptop computer, desktop computer, server computer, mainframe computer, etc. The memory 608 may be any suitable hardware memory or collection of hardware memories, including, but not limited to, RAM, ROM, cache memory, in any relevant form, including solid state, magnetic, optical, etc. Fundamentally, there is no limitation on the type(s) of the memory 608 other than it be hardware memory. In this connection, the term “computer-readable storage medium”, when used herein and/or in the appended claims, is limited to hardware memory and specifically excludes any sort of transient signal, such as signals based on carrier waves. It is also noted that the term “computer-readable storage medium” includes not only single-memory hardware but also memory hardware of differing types. The visual display 612 may be of any suitable form(s), such as a display screen device (touchscreen or non-touchscreen), a projected-display device, or a virtual display device, among others, and any combination thereof. As those skilled in the art will readily appreciate, the particular hardware components of the computing system 600 can be any components compatible with the disclosed methodology and that such components are well-known and ubiquitous such that future elaboration is not necessary herein to enable those having ordinary skill in the art to implement the disclosed methods and software using any such known components.

The computing system 600 also includes at least one HMI 616 that allows a user (not shown) to input gestures (not shown) that the computing system can interpret as item-action gestures and/or as action extensions, examples of which appear in FIGS. 2A through 5C and/or are described above. In some embodiments, the HMI 616 may be a touchscreen of any type (e.g., capacitive, resistive, infrared, surface acoustic wave, etc.), a computer mouse, a trackpad device, a joystick device, a trackball device, or a wearable device having one or more sensors or one or more fiducial markers, among others, and any combination thereof. Fundamentally, there are no limitations on the type(s) of HMI(s) 616 that a user can use to input gestures into the computing system 600 other than that at least one of them allows the user to input the gestures so that the user perceives an item-action gesture that they have input as corresponding to at least one on-display selectable item (not shown).

Methodologies of the present disclosure may be implemented in any one or more suitable manners, such as in operating systems, in web browsers (e.g., as native code or as plugin code), and in software apps, such as, but not limited to, word processing apps, pdf-reader apps, photo-album apps, photo-editing apps, and presentation apps, among many others. In this connection, the memory 608 may include one or more instantiations of software (here, computer-executable instructions 624) for enabling the methodologies on the computing system 600. For example, and as discussed above in connection with the method 100 of FIG. 1, the computer-executable instructions 624 may include a gesture-recognition algorithm 628, an item-determination algorithm 632, and an extension-recognition algorithm 636, among others. Each of these algorithms 628, 632, and 636 may have the same functionalities as described above in connection with the method 100 or functionalities similar thereto and/or modified as needed to suit the particular deployment at issue. The memory 608 may further include a captured-items datastore 640 that in some embodiments at least temporarily stores selected items that one or more users have identified via gesturing methodologies of this disclosure. As those skilled in the art will readily appreciate, the captured-items datastore 640 may be of any suitable format and many store the captured items as copied from the source of the original and/or store pointers to the identified items at either the source or a separate storage location (not show). In some embodiments the captured-items datastore 640 may store other data, such as ratings, rating values, sources of the captured items, app(s) having permissioned access to the captured items, and user(s) having permissioned access to the captured items, among others.

FIG. 6B shows one computing environment 644 of many computing environments in which the computing system of FIG. 6A can be implemented. In this example, the computing environment 644 includes a plurality of webservers 648(1) to 648(N) and a plurality of client devices 652(1) to 652(N) interconnected with one another via a communications network 656. In this example, webserver 648(1) includes at least a portion of the captured-item datastore 640 of the computing system 600 of FIG. 6A. Webservers 648(2) through 648(N) may be, for example, webservers that serve up web pages of tens, thousands, tens of thousands, etc., of websites that are available on the communications network 656, which may include the Internet, and any other networks (e.g., cellular network(s), local-area network(s), wide area network(s), etc.) needed to interconnect the client devices 652(1) to 652(N) to the webservers 648(1) to 648(N) and with one another In some embodiments, webserver 648(1) may also serve up one or more websites and one or more webpages, among other things. In one example, the selected-item datastore 640 on the webserver 648(1) may be part of a cloud-based content organization and management system 658, such as, for example, a cloud-based version of the content organization and management system of International Patent Application PCT/US22/26902, filed on Apr. 29, 2022, and titled “Methods and Software For Bundle-Based Content Organization, Manipulation, and/or Task Management”, which is incorporated by reference herein for its features that are compatible with selecting and/or collecting information as disclosed in this present disclosure.

Client devices 652(1) to 652(N) may be any suitable device that allows corresponding users (not shown) to connect with the network 656. Examples of such devices include, but are not limited to, smartphones, tablet computers, laptop computers, and desktop computers, among others. One, some, or all of the client devices 652(1) to 652(N) may each have a web browser 660 (only shown in client device 652(1) for simplicity) that allows the corresponding user to access websites and webpages served up by the webservers 648(1) to 648(N), as applicable. In this example, the web browser 660 on the client device 652(1) includes one or more software plugins 664 for enabling features of the cloud-based content organization and management system 658 and one or more software plugins 668 for enabling features of the present disclosure. In this example, the software plugin(s) 668 include at least the gesture-recognition algorithm 628, the item-determination algorithm 632, and the extension-recognition algorithm 636 of the computing system 600 of FIG. 6A.

In an example of using the computing system 600 of FIG. 6A as deployed in the computing environment 644 of FIG. 6B, a user (not shown) navigates via the client device 652(1) to a desired webpage (not shown) and decides to identify one or more on-display items displayed on the visual display 612 of the client device for taking one or more actions. While the on-display items are visible on the visual display 612, the user uses the HMI 616 of the client device 652(1) to input an item-action gesture (not shown) over the one or more on-display items the user desires to identify. The gesture-recognition algorithm 628 of the software plugin(s) 668 recognizes the item-action gesture and causes the item-determination algorithm 632 to identify the underlying one or more on-display items as one or more identified item(s) (not shown). In this example, the item-action gesture also causes the computing system 600 (FIG. 6A) to store the identified item(s) in the captured-item datastore 640, here, on the webserver 648(1) (FIG. 6B). In this example, the user continues gesturing via the client device 652(1) so as to make a positive-rating action extension (not shown), which the extension-recognition algorithm 636 recognizes and proceeds to cause the computing system 600 (FIG. 6A) to add the corresponding rating to the captured-item datastore 640 on the webserver 648(1) in association with the identified item(s) just stored there by virtue of the corresponding item-action gesture. The user may use one or more features on the web browser 660 (FIG. 6B) provided by the software plugin(s) 664 to manipulate the stored identified item(s) in the environment provided by the cloud-based content organization and management system 658 (FIG. 6B).

### 4. Example Deployments

With the foregoing general principles in mind, following are descriptions of example deployments of methodologies and software of the present disclosure. It is emphasized that the following subsections 4.1 through 4.4 describe working instantiations and, therefore, describe the instantiation in certain terms. However, it should be kept in mind that the specific instantiations illustrated and described are merely exemplary and should not be considered as limiting in any manner.

### 4.1 Wiggle-Based Gestures

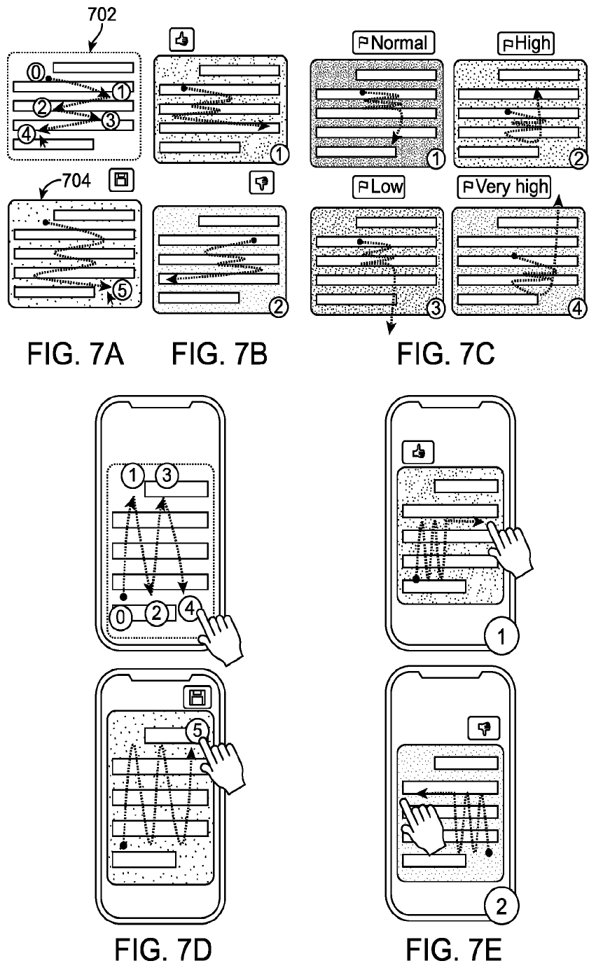

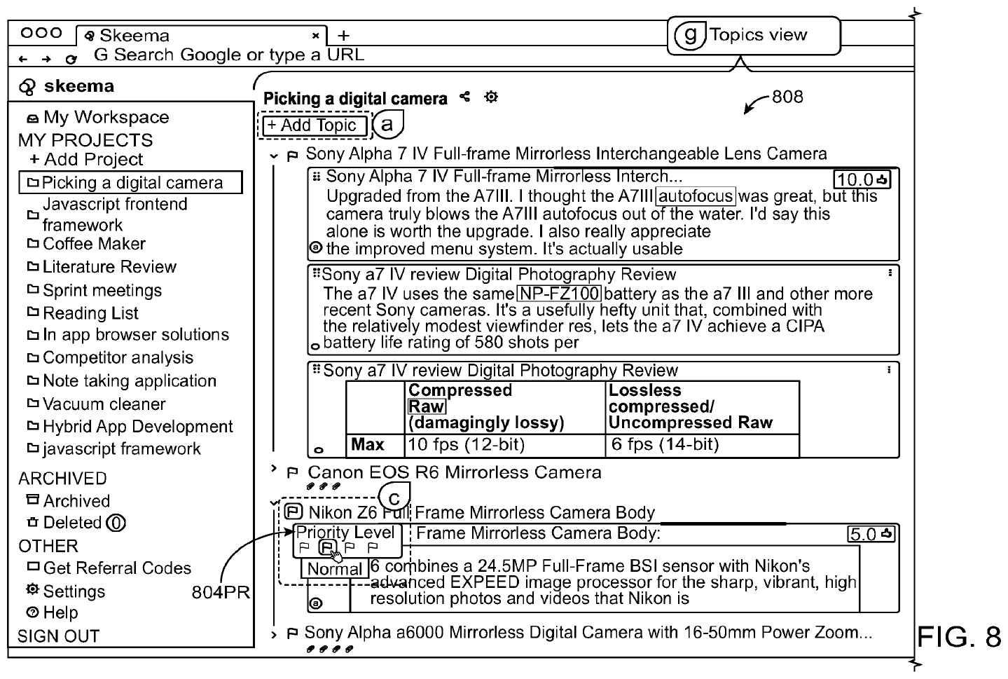

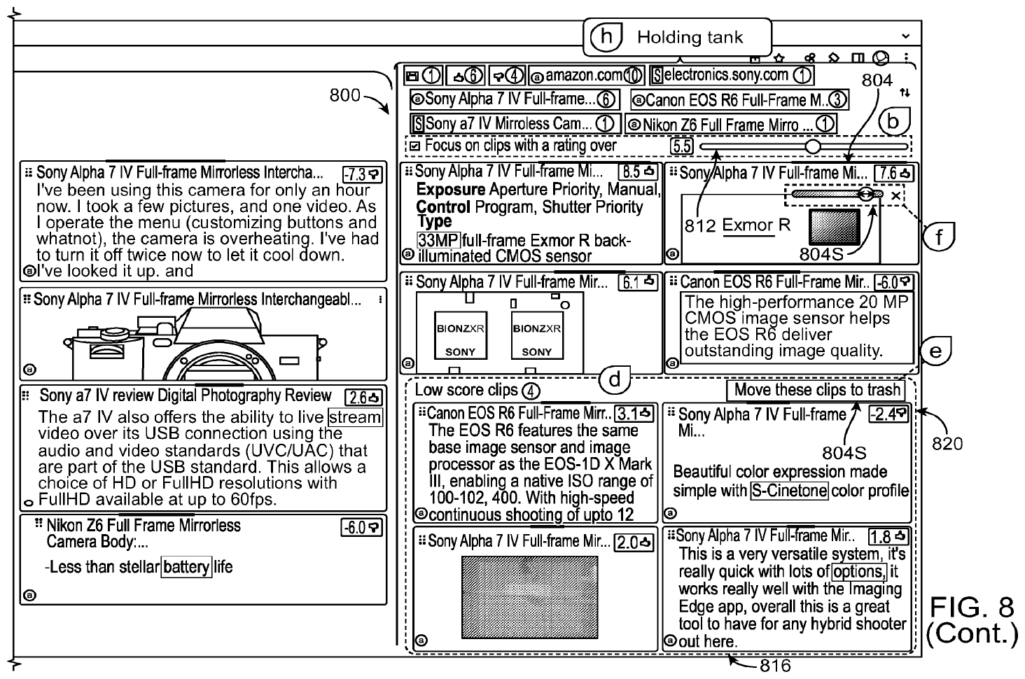

For desktop computers with a traditional computer mouse, trackpad, or trackball input device, the wiggle interaction consists of the following stages, as illustrated in FIGS. 7A through 7C:
(1) Acquiring the collection target: To initiate, users move their mouse pointer (cursor) onto the target content (item(s)) that they would like to collect (See FIG. 7A, at “0”) and initiate the wiggling movement specified in the steps below. This instantiation uses an always-on wiggle gesture recognizer to automatically detect the start of a wiggling gesture. This avoids the requirement of an explicit signal like a keyboard key or mouse-down event, which might conflict with other actions and has the benefit of combining activating and performing the gesture together into a single step, therefore reducing the starting cost of using the interaction technique.
(2) Wiggle: To collect the target content, a user simply moves the mouse pointer left and right approximately inside the target content. To indicate that the computing system is looking to detect the wiggling gesture, it displays a small “tail” 900 (FIG. 9C) that follows the pointer on the screen, and replaces the regular pointer with a special one containing a unique icon. This instantiation also adds a dotted blue border 702 to the target content to provide feedback about what content will be collected, and the blue color grows 704 in shade as users perform more lateral mouse movements (FIG. 7A, at “0” through “4”). This may be considered analogous to a half-press of a camera's shutter button to engage the autofocus system to lock onto a subject when taking photos with a camera. To assist with collecting fine grain targets, ranging from a word to a block (e.g., a paragraph, an image, etc.), this instantiation allows users to vary the average size of their wiggling to indicate the target that they would like to collect. If the average size of the last five lateral movements of a pointer is fewer than 65 pixels (a threshold empirically tuned that worked well in pilot testing and user study, but implemented as a customizable parameter that individuals can tune based on their situations), this instantiation will select the word that is covered at the center of the wiggling paths. Larger lateral movements will select a block-level content (details discussed in section 4.3.2, below). In addition, users can abort the collection process by simply stopping wiggling the mouse pointer before there are sufficient back-and-forth movements.
(3) Collection: As soon as users make at least five back and forth motions (optimized for the amount of physical effort required and the number of false positive detection through pilot testing, but is also implemented as a parameter that can be customized by individuals in practice, details discussed below in section 4.3.1), the system will commit to the collection and gives the target a darker blue background showing that a wiggle has been successfully activated (as shown in FIG. 7A, at “5”). If users want to collect multiple blocks of content, they can just naturally continue to wiggle over other desired content after this activation. Or, they can stop wiggling. However, if users have selected the wrong target, an undo button 904 (FIG. 9E) appears, which can be clicked to cancel the collection.
(4) Extension: Instead of just stopping the wiggle motion after collection, users can leverage the last wiggle movement and turn it into a “swipe”, either horizontally to the right or left to encode a positive or negative valence rating (as shown in FIG. 7B, at “1” and “2”), or vertically down or up to specify a topic and priority for that topic (as shown in FIG. 7C, at “1” through “4”). Feedback for the action extension uses different colors for the background of the target content to provide visual salience (details discussed in section 4.2, below).

Similarly, and as seen in FIGS. 7D and 7E, for touchscreen-based computing devices:
(1) Acquiring collection target: To initiate, the user touches a finger to the touchscreen over the target content that they want the computing system to select (FIG. 7D, at “0”).
(2) Wiggle: To collect the target content (selected item(s)), the user keeps the finger on the touchscreen and starts making small up-and-down scrolling movements. Similar to the above traditional mouse device scenario, the computing system adds a dotted blue border to the target content to provide feedback that the wiggling is being detected (FIG. 7D, at “0” through “4”). Note that due to the limitations of the large size of the finger with respect to an individual word, as well as the unique use cases of mobile devices (e.g., quickly consuming and collecting blocks of information on the go), the mobile-only instantiation supports selecting block-level content, such as paragraphs and images.
(3) Collection: As soon as the user makes at least five up-and-down motions, the computing system will commit to the collection by giving the target a darker blue background (FIG. 7D, at “5”. Now, the user can stop wiggling and lift the finger from the screen. Similar to the desktop version, an “undo” button pops up that lets the user cancel the collection in case of an error. Note that due to the limited screen area that typical mobile devices afford, additional blocks of content will typically have to be first scrolled into view for users to then capture them, which would make the interaction less fluid.
(4) Extension: Instead of stopping the wiggle motion after making the item-action gesture and, therefore, the collection, users can continue the wiggling and end it with a horizontal swipe to the left or right to achieve similar encoding capabilities described above for the non-touchscreen version (as seen in FIG. 7E, at “1” and “2”). After the computing system detects an item-action gesture, it turns off other actions until the finger is lifted so that the swipes do not perform their normal actions. (But the normal swipes, scrolling, and other interactions still work normally when not preceded by an item-action gesture.) Currently, since this instantiation already uses the vertical dimension for detecting wiggling movement on a mobile device and large cross-screen vertical movements are difficult to perform, especially when holding and interacting with a single hand, we opted not to make a mobile equivalent of encoding topic priorities using long vertical extensions.

### 4.2 An Overview of the Instantiated System and Methods

The present instantiation enables users to collect and triage web content via wiggling. First, after an item-action gesture 908 with no extension (FIG. 9C), this instantiation presents a popup dialog window 912 (FIG. 9C) directly near the collected content to indicate success. The popup dialog window 912 presents a notes field 912NF (FIG. 9C), and users can assign a valence rating via a rating slider 912S (FIG. 9C) and pick the topic in a topic field 912TF (FIG. 9C) that this piece of information should be organized in. By default, the topic field 912TF goes into the last topic the user picked or a holding tank (see, e.g., holding tank 800 of FIG. 8) if none was picked initially. The present instantiation preserves and subsequently shows the content of the selected item(s) with its original cascading style sheet (CSS) styling, including any rich, interactive multimedia objects supported by HTML, like links and images. This makes the content more understandable and useful, and also helps users quickly recognize a particular piece of information among many others by its appearance.

A more fluid way to encode user judgements than the example described above is to leverage a natural extension of the wiggling item-action gesture discussed above in section 4.1. That is, to encode a valence rating in addition to collecting a piece of content, users can end a wiggle with a horizontal “swipe” action extension, either to the right to indicate positive rating (or “pro”, characterized, for example, by a green-ish color that the background of the target content turns into, and a thumbs-up icon 920, as shown in FIG. 9D), or the left for negative rating (or “con”, characterized, for example, by a red-ish color that the background of the collected block turns into, and a thumbs-down icon 924, as shown in FIG. 9E). Optionally, users can also turn on real-time visualizations of “how much” they swiped to the left or right to encode a rating score representing the degree of positivity or negativity and can adjust that value in the popup dialog box 928 (FIG. 9D) via the rating slider 928S or from a rating slider 804S on an information card 804 as seen in FIG. 8. Behind the scenes, the computing system calculates a value as a function of a score based on the horizontal distance the pointer traveled leftward or rightward from the average wiggle center of the item-action gesture divided by the available distance the pointer could theoretically travel until it reaches either edge of the corresponding browser window (not shown). This score is then scaled to be in the range of −10 to 10 in this example.

Alternatively, to directly create a topic and assign a priority to it from wiggling, users can either append the wiggle-type item-action gesture with a swipe up (encoding “high”, characterized, for example, by a yellow-ish color 902 that the background of the target content turns into, as shown in FIG. 9A) or swipe down (encoding “normal”, characterized by a gray-ish color 906 that the background of the target content turns into, as shown in FIG. 9B). Optionally, if the user swipes all the way up or down to the edge of the browser window, the present instantiation will additionally assign two more levels of priorities, “urgent” and “low”, respectively, indicated by a bright orange 910 and a muted gray color 914 (FIG. 9B), which can be adjusted in a priority-selection region 932PR in the popup dialog box 932 (FIG. 9B) as well as in a priority-selection region 804PR (FIG. 8) within a topics view region 808 (FIG. 8). In this case, the selected item will instead be used as the default title of a newly created information card (see, e.g., information card 804 of FIG. 8), which users can change in a popup dialog box 936 (FIG. 9A) directly as shown in a title region 936TR of the popup dialog box or later in the topics view.

To help users better manage the information that they have gathered in a holding tank (e.g., the holding tank 800 of FIG. 8), the present instantiation offers several additional features. First, it enables users to sort the information cards by various criteria, such as in the order of valence ratings or in temporal order. Second, it offers category filters automatically generated based on the encodings that users provided using wiggling (or edited later) and the provenance of information (where it was captured from). Users can quickly toggle those on or off to filter the collected information. Third, users can quickly filter out information with a lower rating (e.g., indicating that it was less impactful to a user's overall goal and decision making) by adjusting the threshold using the “Focus on clips with a rating over threshold” slider 812 shown in FIG. 8. As a result, clips with rating scores lower than the set threshold would be automatically grouped together in a region 816 at the end of the listing and grayed out, and users can easily archive or put them into the trash in a batch by clicking the “Move these clips to trash” button 820. These organizational features further help users reduce clutter in the holding tank and provide a scaffold for them to start dragging and dropping clips into their respective topics.

### 4.3 Design and Implementation Considerations

This section discusses design and implementation considerations made through prototyping the present instantiation with JavaScript in a browser to provide an interaction that could simultaneously reduce cognitive and physical costs of capturing information while providing natural extensions to easily and optionally encode aspects of users' mental context during sensemaking. It has been hypothesized that such an effective interaction should have the following characteristics:
(1) Accuracy: It needs to be accurate and precise enough to lock onto the content the users intend to collect.
(2) Efficiency: It should be quick and low-effort to perform, and minimize interruptions to the main activities that users are performing, such as learning and active reading.
(3) Expressiveness: It should be extendable to provide natural and intuitive affordances for users to express aspects of their mental context at the moment. In the scope of this work, we would like to have wiggling support encoding valence ratings as well as topic priorities.
(4) Integration: It should be a complement to and not interfere with the existing interactions that users already use, such as using the pointer to select text and pictures or click on links. For example, the identification and manipulation of on-display items is completely independent of conventional item selection (e.g., highlighting of text, selection of graphics, etc.), without changing the contents of a copy-and-paste clipboard, etc.

4.3.1 Recognizing a wiggle gesture as an item-action gesture. Several options were performed for accurately recognizing a wiggle pattern. One way is to use an off-the-shelf gesture recognizer. Although some of these recognizers may be lightweight and easy to customize, they are fundamentally designed to recognize distinguishable shapes such as circles, arrows, or stars, while the path of the example wiggle gesture does not conform to a particular shape that is easily recognizable (indeed, for some embodiments it can be argued that an item-action gesture should not conform to any particular shape, the sketching of which would increase the cognitive and physical demand). A second option investigated was to build a custom computer vision-based wiggle recognizer using transfer learning from lightweight image classification models. Though these ML-based models improved the recognition accuracy in internal testing, they incurred a noticeable amount of delay due to browser resource limitations (and limitations in network communication speed when hosted remotely). This made it difficult for the system to perform eager recognition (recognizing the gesture as soon as it is unambiguous rather than waiting for the mouse to stop moving), which is needed to provide real-time feedback to the user on their progress.

To address these issues, the present inventors discovered that a common pattern in all of the wiggle paths that users generated with a computer mouse or trackpad during pilot testing share the characteristic that there were at least five (hence the activation threshold mentioned in section 4.1, above, in connection with enumerated items 3 regarding collection) distinguishable back and forth motions in the horizontal direction, but inconsistent vertical direction movements. Similarly, on smartphones, wiggling using a finger triggers at least five consecutive up and down scroll movements in the vertical direction but inconsistent horizontal direction movements. Therefore, the inventors hypothesized that, at least for some embodiments, only leveraging motion data in the principle dimension (horizontal on desktop, and vertical on mobile) would be sufficient for a custom-built gesture recognizer to differentiate intentional wiggles from other kinds of motions by a cursor or finger.

Based on an implementation using JavaScript in the browser, the present inventors found that the developed gesture-recognizer successfully supports real-time eager recognition with no noticeable impact on any other activities that a user performs in a browser. Specifically, the computing system starts logging all mouse movement coordinates (or scroll movement coordinates on mobile devices) as soon as any mouse (or scroll) movement is detected, but still passes the movement events through to the rest of the DOM tree elements so that regular behavior would still work in case there is no wiggle. In the meantime, the computing system checks to see if the number of reversal of directions in the movement data in the principle direction exceeds the activation threshold, in which case an item-action gesture will be registered by the system. After activation, the computing system will additionally look for a possible subsequent wide horizontal or vertical swipe movement (for creating topics with priority or encoding valence to the collected information) without passing those events through to avoid unintentional interactions with other UI elements on the screen. As soon as the mouse stops moving, or the user aborts the wiggle motion before reaching the activation threshold, the computing system will clear the tracking data to prepare for the next possible wiggle event.

4.3.2 Target Acquisition. In order to correctly lock onto the desired content without ambiguity, we explored two approaches that we applied in concert in the present instantiation. The first approach is to constrain the system to only be able to select certain targets that are usually large enough to contain a wiggling path and semantically complete. For example, one could limit the system to only engage wiggle collections on block-level semantic HTML elements, such as <div>, <p>, <h1>-<h6>, <li>, <img>, <table>, etc. This way, the system will ignore inline elements that are usually nested within or between a block-level element. This approach, though sufficient in a prototype application, does rely on website authors to organize content with semantically appropriate HTML tags.

The second approach is to introduce a lightweight disambiguation algorithm that detects the target from the mouse pointer's motion data in case the previous one did not work, especially for a small <span> or an individual word. To achieve this, the inventors chose to take advantage of the pointer path coordinates (both X and Y) in the last five lateral mouse pointer movements and choose the target content covered by the most points on the path. Specifically, re-sampling and linear interpolation techniques sample the points on a wiggle path to mitigate variances caused by different pointer movement speeds as well as the frequency at which a browser dispatches mouse movement events.

On mobile devices, since the vertical wiggling gesture triggers the browser's scrolling events, the target moves with and stays underneath the finger at all times. Therefore, the identification is based on the content under the initial touch position.

In the present instantiation and when the computing system is unable to find a selectable item (e.g., when there is no HTML element underneath where the mouse pointer or the finger resides) using the methods described above, it does not trigger a wiggle activation (and also not the aforementioned set of visualizations), even if a “wiggle action” was detected. This was an intentional design choice to further avoid false positives as well as to minimize the chances of causing distractions to the user.

4.3.3 Integration with existing interactions. The wiggling interaction does not interfere with common active reading interactions, such as moving the mouse pointer around to guide attention, regular vertical scrolling or horizontal swiping (which are mapped to backward and forward actions in both Android and iOS browsers). In addition, wiggling can co-exist with conventional precise content selection that are initiated with mouse clicks or press-and-drag-and-release on desktops or long taps or edge taps on mobile devices. Furthermore, unlike prior work that leverages pressure-sensitive touch screens to activate a special selection mode, the wiggling interaction does not require special hardware support, and can work with any kind of pointing device or touchscreen.

### 4.4 Implementation Notes

In this example instantiation, the wiggling technique was implemented as an event-driven JavaScript library that can be easily integrated into any website and browser extension. Once imported, the library will dispatch wiggle-related events once it detects them. Developers can then subscribe to these events in the applications that they are developing. All the styles mentioned above are designed to be easily adjusted through predefined CSS classes. The library itself was written in approximately 1,100 lines of JavaScript and TypeScript code.

The instant browser extension has been implemented in HTML., Type-Script, and CSS and uses the React JavaScript library for building UI components. It used Google Firebase for backend functions, database, and user authentication. In addition, the extension has been implemented using the now-standardized Web Extensions APIs so that it would work on all contemporaneous major browsers, including Google Chrome, Microsoft Edge, Mozilla Firefox, Apple Safari, etc.

The instant mobile application has been implemented using the Angular JavaScript library and the Ionic Framework and works on both iOS and Android operating systems. Due to the limitations that none of the current major mobile browsers have the necessary support for developing extensions, this instantiation implemented its own browser using the InAppBrowser plugin from the open-source Apache Cordova platform to inject into webpages the JavaScript library that implements wiggling as well as custom JavaScript code for logging and communicating with the Firebase backend.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A method of controlling a computing system via a visual display driven by the computing system, the method being performed by the computing system and comprising:
monitoring input of a user so as to recognize when the user has formed an item-action gesture; and
in response to recognizing the item-action gesture without presence of another user-input action upon the computing system:
identifying an on-display item, displayed on the visual display, that corresponds to the item-action gesture; and
manipulating the identified on-display item.

2. The method of claim 1, wherein monitoring input of the user includes monitoring movement by the user of an onscreen cursor.

3. The method of claim 1, wherein monitoring input of the user includes monitoring scrolling performed by the user.

4. The method of claim 1, wherein the visual display comprises a touchscreen, and monitoring input of the user includes monitoring movement by the user of a pointer engaged with the touchscreen.

5. (canceled)

6. (canceled)

7. The method of claim 1, wherein the visual display has a display area, and the item-action gesture includes a multi-directional trajectory comprising multiple contiguous segments extending in differing directions relative to the display area.

8. The method of claim 7, wherein the item-action gesture comprises a wiggling gesture.

9. The method of claim 68, wherein the wiggling gesture includes a zig-zag trajectory.

10. The method of claim 7, wherein the item-action gesture comprises a curvilinear shape.

11. The method of claim 10, wherein the item-action gesture comprises a repetition of the curvilinear shape, and the repetition proceeds al ing a procession direction.

12. (canceled)

13. The method of claim 8, wherein the multi-directional gesture is primarily horizontal relative to the visual screen.

14. (canceled)

15. The method of claim 7, wherein the multi-directional gesture is primarily vertical relative to the screen display.

16. (canceled)

17. The method of claim 7, wherein the item-action gesture comprises a plurality of segment-swipes, wherein each transition between adjacent segment swipes forms an abrupt angle.

18. The method of claim 17, wherein the abrupt angle is in a range of 0 degrees to 90 degrees, inclusive.

19. (canceled)

20. The method of claim 1, wherein the item-action gesture includes an action extension, and the method further comprises:
monitoring input of the user so as to recognize when the user has formed an action extension of the item-action gesture; and
in response to recognizing the action extension, executing an action relative to the identified on-display item.

21. The method of claim 20, further comprising monitoring movement by the user of the screen pointer relative to the display screen so as to recognize directionality of the action extension and determining the action based on the directionality.

22. The method of claim 20, wherein the action includes assigning a valence to the identified on-display item.

23. The method of claim 22, wherein the valance has a state that is a function of directionality of the extension.

24. The method of claim 1, wherein determining an on-display item corresponding to the item-action gesture includes mapping an on-display location of at least a portion of the item-action gesture to an on-display location of the on-display item.

25. The method of claim 24, wherein mapping the on-display location of at least a portion of the item-action gesture to an on-display location of the on-display item uses a cascading style sheet.

26. The method of claim 1, wherein manipulating the identified on-display item includes capturing the identified on-display item.

27. The method of claim 26, wherein capturing the on-display item includes copying one or more HTML objects from an HTML description.

28. The method of claim 1, wherein the item-action gesture comprises a reciprocating scrolling action.

29. (canceled)

30. (canceled)

31. (canceled)

32. The method of claim 28, wherein the user actuates a scroll controller of a human-machine-interface device to effect the reciprocating scrolling action.

33. (canceled).

34. The method of claim 1, wherein without presence of another user-input action upon the computing system includes without the presence of a user actuating a control of a human-machine-interface device.

35. The method of claim 1, wherein monitoring input of a user includes monitoring user input of a gesture, the method further comprising:
treating the item-action gesture as having differing control segments; and
performing differing actions for the differing control segments.

36. The method of claim 35, wherein the differing control segments comprise a suspected-gesture segment and a confirmed-gesture segment.

37. The method of claim 1, wherein when the user forms the item-action gesture, the on-display item was not already selected.

38. The method of claim 1, wherein when the user forms the item-action gesture, the on-display item is in a selected state.

39. The method of claim 38, wherein manipulation of the identified on-display item does not change the selected state.

40. A computer-readable storage medium containing computer-executable instructions for performing the method of any of claims 1-39.
